(19) United States
(12) Patent Application Publication
(10) Pub. No.: US 2022/0003853 A1
(43) Pub. Date: Jan. 6, 2022

(54) DISTANCE MEASURING DEVICE AND MALFUNCTION DETERMINATION METHOD FOR DISTANCE MEASURING DEVICE

(71) Applicant: DENSO CORPORATION, Kariya-city (JP)

(72) Inventors: Noriyuki OZAKI, Kariya-city (JP); Masato RINNAI, Kariya-city (JP); Takehiro HATA, Kariya-city (JP)

(21) Appl. No.: 17/478,731

(22) Filed: Sep. 17, 2021

Related U.S. Application Data
(63) Continuation of application No. PCT/JP2020/004276, filed on Feb. 5, 2020.

(30) Foreign Application Priority Data
Mar. 19, 2019 (JP) 2019-051075

(51) Int. Cl. G01S 7/497; G01S 7/48; G01S 17/08

(52) U.S. Cl. CPC G01S 7/497; G01S 17/08; G01S 7/4808

(57) ABSTRACT

A distance measuring device includes a light receiving unit and a light emitting unit. The light receiving unit includes light-receiving regions for receiving incident light and receives the incident light in units of each light-receiving region. The light emitting unit exclusively emits detection light corresponding to each light-receiving region. The distance measuring device further includes a malfunction determining unit that, in response to the light receiving unit receiving the incident light according to the emission of the detection light, performs malfunction determination in the distance measuring device, in accordance with a difference between a property of incident light intensity in a light-receiving subject region and a property of incident light intensity in a light-receiving non-subject region, the light-receiving subject region corresponding to exclusive emission of the detection light and the light-receiving non-subject region failing to correspond to exclusive emission of the detection light, among the light-receiving regions.

### CROSS-REFERENCE TO RELATED APPLICATION

The present application is a continuation application of International Application No. PCT/JP2020/004276, filed on Feb. 5, 2020, which claims priority to Japanese Patent Application No. 2019-051075, filed on Mar. 19, 2019. The contents of these applications are incorporated herein by reference in their entirety.

### BACKGROUND

### Technical Field

The present disclosure relates to malfunction determination technique for a distance measuring device that uses a laser beam.

### Background Art

An optical distance measuring device that detects an object using a laser beam has been proposed.

### SUMMARY

In the present disclosure, provided is a distance measuring device as the following.

The distance measuring device includes a light receiving unit configured to receive the incident light in units of each light-receiving region; a light emitting unit configured to exclusively emit detection light to the outside corresponding to each light-receiving region; and a malfunction determining unit configured to perform, in response to the light receiving unit receiving the incident light according to the emission of the detection light, malfunction determination regarding at least one of the light receiving unit and the light emitting unit, in accordance with a difference between a property of incident light intensity in a light-receiving subject region and a property of incident light intensity in a light-receiving non-subject region.

### BRIEF DESCRIPTION OF THE DRAWINGS

FIG. 1 is an explanatory diagram illustrating a schematic configuration of a distance measuring device according to a first embodiment;

FIG. 2 is a block diagram illustrating a functional configuration of a control unit of the distance measuring device according to the first embodiment;

FIG. 3 is an explanatory diagram schematically illustrating a light-receiving element array included in the distance measuring device according to the first embodiment together with an example of histograms of each of the light-receiving regions;

FIG. 4 is an explanatory diagram schematically illustrating a light-emitting element of the distance measuring device according to the first embodiment;

FIG. 5 is an explanatory diagram illustrating an example of a timing at which a light-receiving process and a light-emitting process are performed in the distance measuring device according to the first embodiment;

FIG. 6 is a flowchart showing a process flow for determining a malfunction executed by the distance measuring device according to the first embodiment;

FIG. 7 is an explanatory diagram illustrating an example of how light is received by the light-receiving element array;

FIG. 8 is a flowchart showing a process flow for determining a malfunction executed by a distance measuring device according to a second embodiment;

FIG. 9 is a flowchart showing a process flow for determining a malfunction executed by a distance measuring device according to a third embodiment; and

FIG. 10 is an explanatory diagram schematically illustrating a light-receiving element array according to another embodiment.

### DETAILED DESCRIPTION OF THE PREFERRED EMBODIMENTS

An optical distance measuring device that detects an object using a laser beam has been proposed (for example, Japanese Laid-Open Patent Publication No. 2012-60012, Japanese Laid-Open Patent Publication No. 2016-176750).

However, in the conventional distance measuring device, there have not been sufficient studies on determining, by the device itself, a malfunction in the distance measuring device such as a decrease in the signal-noise (S/N) ratio caused due to the displacement of a light receiving unit or a light emitting unit in the distance measuring device or the adhesion of contamination on an optical system, and on the improvement of accuracy in determining a malfunction.

Given the circumstances, it has been desired that determination of a malfunction by the device itself be performed regarding at least one of the light receiving unit and the light emitting unit in the distance measuring device.

The present disclosure is achieved in the following aspect.

A first aspect provides a distance measuring device. The distance measuring device of the first aspect includes a light receiving unit configured to include a plurality of light-receiving regions for receiving incident light and receive the incident light in units of each light-receiving region; a light emitting unit configured to exclusively emit detection light to the outside corresponding to each light-receiving region; and a malfunction determining unit configured to perform, in response to the light receiving unit receiving the incident light according to the emission of the detection light, malfunction determination regarding at least one of the light receiving unit and the light emitting unit, in accordance with a difference between a property of incident light intensity in a light-receiving subject region and a property of incident light intensity in a light-receiving non-subject region, a region corresponding to the exclusive emission of the detection light among the plurality of light-receiving regions serving as the light-receiving subject region, and a region failing to correspond to the exclusive emission of the detection light among the plurality of light-receiving regions serving as the light-receiving non-subject region.

The distance measuring device according to the first aspect determines a malfunction by itself regarding at least one of the light receiving unit and the light emitting unit in the distance measuring device.

A second aspect provides a malfunction determination method for a distance measuring device, the distance measuring device including a light receiving unit and a light emitting unit. The malfunction determination method for a distance measuring device according to the second aspect includes exclusively emitting detection light to the outside, in units of each of a plurality of light-receiving regions included in the light receiving unit; and executing, in response to the light receiving unit receiving incident light according to the emission of the detection light, malfunction determination regarding at least one of the light receiving unit and the light emitting unit, in accordance with a difference between a property of incident light intensity in a light-receiving subject region and a property of incident light intensity in a light-receiving non-subject region, the light-receiving subject region corresponding to the exclusive emission of the detection light among the plurality of light-receiving regions, and the light-receiving non-subject region failing to correspond to the exclusive emission of the detection light among the plurality of light-receiving regions.

The malfunction determination method for a distance measuring device according to the second aspect determines a malfunction by itself regarding at least one of the light receiving unit and the light emitting unit in the distance measuring device. Note that, the present disclosure can be achieved as a program for determining a malfunction in a distance measuring device or a computer-readable storage medium that stores the program.

A distance measuring device and a malfunction determination method for the distance measuring device according to an embodiment of the present disclosure will now be described.

### First Embodiment

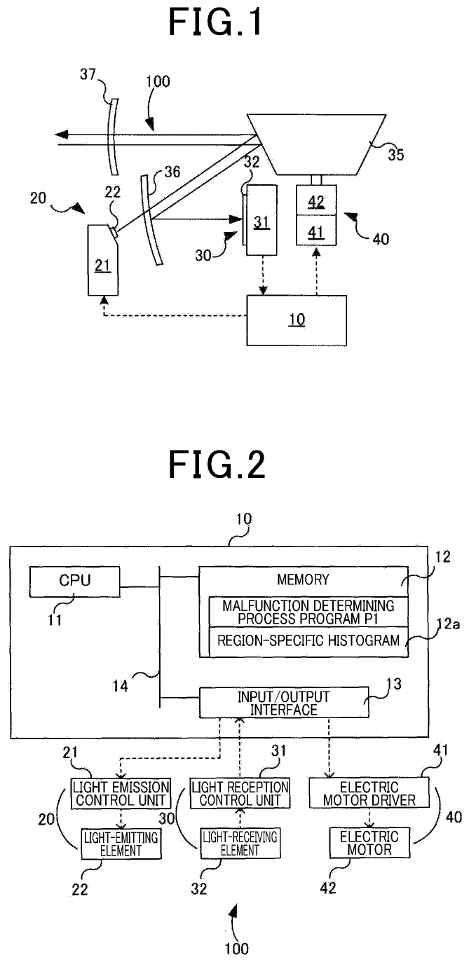

As shown in FIG. 1, a distance measuring device 100 according to a first embodiment includes a control unit 10, a light emitting unit 20, a light receiving unit 30, and an electric driving unit 40. The distance measuring device 100 is mounted on, for example, a vehicle and is used for detecting objects around the vehicle. The distance measuring device 100 has a predetermined scan angle range, and the scan angle range is divided into a plurality of angles, each angle serves as a unit scan angle. Distance measuring of the entire scan angle range is performed by emitting detection light by the light emitting unit 20 in units of the unit scan angle and receiving the reflected light by the light receiving unit 30. The unit scan angle determines the resolving power of the distance measuring device 100 or the resolution of the distance measuring result obtained by the distance measuring device 100. The smaller the unit scan angle, the higher the resolving power and the resolution. Hereinafter, the unit scan angle is also referred to as a scan column and is sometimes given a reference sign such as a scan column N and a scan column N+1 to distinguish each scan column. The detection result of an object is used as a determination parameter for driving assistance such as driving force control, braking assistance, and steering assistance. The distance measuring device 100 only needs to include at least the control unit 10, the light emitting unit 20, and the light receiving unit 30. The distance measuring device 100 is, for example, light detection and Ranging (Lidar) and includes a scanning mechanism 35, which is rotated by the electric driving unit 40, and a half mirror 36, which allows a laser beam emitted from the light emitting unit 20 to pass through and reflects the incident light. In the present embodiment, the light emitting unit 20 or the light receiving unit 30 may include at least the scanning mechanism 35 and the half mirror 36, which form an optical path of emitted light or received light, and may also include a cover glass 37 of the distance measuring device 100 or a non-illustrated lens. In this case, these may be referred to as a light-emitting system or a light-receiving system.

The control unit 10 includes a computation unit, which is a central processing unit (CPU) 11, a storage unit, which is a memory 12, an input/output unit, which is an input/output interface 13, and a non-illustrated clock generator. The CPU 11, the memory 12, the input/output interface 13, and the clock generator are connected to each other through an internal bus 14 to allow interactive communication. The memory 12 includes a memory that stores a malfunction determining process program P1 in a non-volatile and read-only manner, such as a read-only memory (ROM), and a memory that allows the CPU 11 to read and write, such as a random-access memory (RAM), the malfunction determining process program P1 determining a malfunction regarding at least one of the light receiving unit and the light emitting unit of the distance measuring device 100 in accordance with the difference between the property of the incident light intensity in a light-receiving subject region and the property of the incident light intensity in a light-receiving non-subject region. The readable and writable memory or region in the memory 12 includes a region-specific histogram storage region 12a, which stores a histogram generated for each of light-receiving regions of the light receiving unit 30. The CPU 11, that is, the control unit 10 functions as a malfunction determining unit by extracting the malfunction determining process program P1 stored in the memory 12 to the readable and writable memory and executing the malfunction determining process program P1. Note that, the CPU 11 may be a single unit CPU or may be multiple CPUs that execute respective programs. Alternatively, the CPU 11 may be a multi-task CPU that is capable of executing multiple programs simultaneously. Additionally, when the malfunction determining process program P1 is executed only for the determination of a malfunction, the memory 12 may store a distance measuring program for executing a distance measuring process. By executing the distance measuring program, the CPU 11 functions as a distance measuring control unit, and the distance measuring device 100 calculates the distance between an object and the distance measuring device 100.

The input/output interface 13 is connected to a light emission control unit 21, a light reception control unit 31, and an electric motor driver 41 through respective control signal lines. A light emission control signal is transmitted to the light emission control unit 21, an incident light intensity signal is received from the light reception control unit 31, and a rotational speed instruction signal is transmitted to the electric motor driver 41.

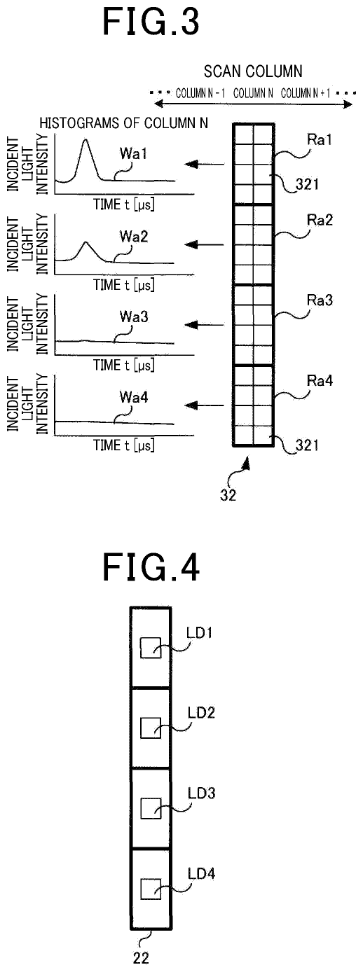

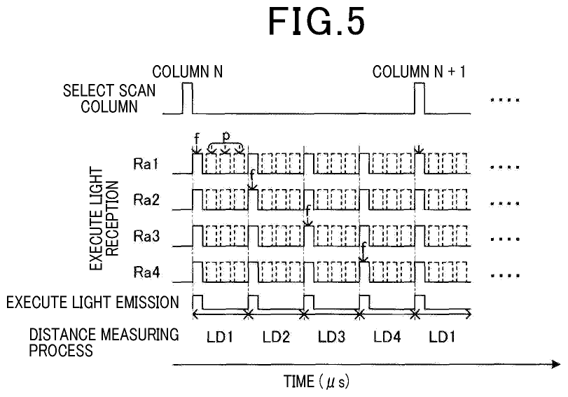

The light receiving unit 30 includes, in a narrow sense, the light reception control unit 31 and a light-receiving element array 32. The light-receiving element array 32 is a plate-like optical sensor on which multiple light-receiving elements are arranged in the vertical and horizontal directions. The light-receiving elements are configured by, for example, single-photon avalanche diodes (SPADs) or other photodiodes. Note that, the term “light-receiving pixel” is sometimes used as the minimum unit in a light-receiving process. In this case, each light-receiving pixel is configured by a single light-receiving element or multiple light-receiving elements, and the light-receiving element array 32 includes multiple light-receiving pixels. The light-receiving element array 32 is divided into multiple light-receiving regions. The light-receiving region is a unit of the light-receiving region on which the light reception control unit 31 executes the light-receiving process, that is, a unit including a group of light receiving elements or a group of light-receiving pixels, used in the distance measuring process of receiving the reflected light of the detection light emitted from the light emitting unit 20. In the present embodiment, the light-receiving element array 32 is divided into, for example, four light-receiving regions Ra1 to Ra4 identified by reference numerals as shown in FIG. 3. Each of the light-receiving regions Ra1 to Ra4 is configured by eight light-receiving pixels 321. As shown in FIG. 5, the light reception control unit 31 executes the light-receiving process of outputting an incident light intensity signal corresponding to the amount of incident light or the intensity of incident light that has entered each light-receiving region per unit scan angle, that is, in units of the scan columns. In FIG. 5, the reference sign f indicates the execution of the light-receiving process for a case in which the light emission by the light emitting unit 20 to each scan column is performed once. The reference sign f+p indicates the execution of the light-receiving process for a case in which the light emission by the light emitting unit 20 to each scan column is performed multiple times, which is four times in the example of FIG. 5. In general, when each pixel of the light-receiving element array 32 is configured by multiple light-receiving elements, an incident light intensity signal is generated by one light emission and the light-receiving process of adding up the detection values of the light-receiving elements, and when each pixel of the light-receiving element array 32 is configured by a single light-receiving element or a few light-receiving elements, the incident light intensity signal is generated by a multiple number of times of the light emission and a multiple number of times of the light-receiving processes that do not involve the addition. This improves the signal-noise (S/N) ratio. Specifically, in the light-receiving process, the light reception control unit 31 adds up the current generated by the light-receiving pixels that configure each light-receiving region in accordance with the incident light amount or the voltage converted from the current for each scan column in units of the light-receiving regions and outputs the result as the incident light intensity signal to the control unit 10. In other words, the incident light intensity signal corresponding to the total number of photons received by the light-receiving elements that configure each light-receiving pixel is output to the control unit 10.

The light emitting unit 20 includes, in a narrow sense, the light emission control unit 21 and the light-emitting element 22 and emits detection light per unit scan angle. The light-emitting element 22 is, for example, an infrared laser diode and outputs an infrared laser beam as the detection light. The light emitting unit 20 includes, as shown in FIG. 4, light-emitting elements LD1 to LD4. Each of the light-emitting elements LD1 to LD4 is associated with the corresponding one of the light-receiving regions Ra1 to Ra4. In response to the light emission control signal that instructs exclusive light emission of the four light-emitting elements LD1 to LD4 input per unit scan angle from the control unit 10 through the input/output interface 13, the light emission control unit 21 exclusively drives the light-emitting elements LD1 to LD4 based on a drive signal having a pulse drive waveform as shown in FIG. 5 and emits an infrared laser beam corresponding to each of the light-receiving regions Ra1 to Ra4. That is, the light emitting unit 20 and the light receiving unit 30 are optically configured such that a region irradiated or scanned with the detection light exclusively emitted by one light-emitting element in units of the unit scan angle is associated with one light-receiving region. The reflected light from the object that exists in one irradiated region enters one associated light-receiving region. Additionally, the light-receiving process performed by the light reception control unit 31 in units of each light-receiving region is a process executed at a timing when associated one light-emitting element exclusively emits the detection light. Note that, to simplify the description, FIG. 4 shows the light emitting unit 20 including four light-emitting elements LD1 to LD4 corresponding to the light-receiving regions Ra1 to Ra4 as an example. However, the light emitting unit 20 only needs to include one light-emitting element 22. In this case, the reference signs LD1 to LD4 in FIG. 4 schematically show a timing when a single light-emitting element 22 exclusively emits light. In a case in which multiple light-emitting elements 22 are provided, for example, the scanning mechanism 35 may omit the scanning in the vertical direction and only needs to scan in the horizontal direction. In a case in which a single light-emitting element 22 is provided, the scanning mechanism 35 scans in the vertical direction in addition to the horizontal direction.

The electric driving unit 40 includes the electric motor driver 41 and an electric motor 42. The electric motor driver 41 changes the application voltage to the electric motor 42 in response to the rotational speed instruction signal from the control unit 10 and controls the rotational speed of the electric motor 42. The electric motor 42 may be, for example, a brushless motor or a brush motor. At the distal end portion of the output shaft of the electric motor 42 is mounted the scanning mechanism 35. The scanning mechanism 35 is a reflector, that is, a mirror, that scans the detection light output from the light-emitting element 22 in the horizontal direction and is able to scan in the horizontal direction by being rotated by the electric motor 42. The scanning mechanism 35 scans the detection light and receives the reflected light in a scan angle range of, for example, 120 degrees or 180 degrees. The scanning mechanism 35 may further scan in the vertical direction instead of or in addition to the horizontal direction. To enable the scanning in the horizontal direction and the vertical direction, the scanning mechanism 35 may be a multifaceted mirror such as a polygon mirror or may include a single-faceted mirror equipped with a mechanism that swings in the vertical direction or another single-faceted mirror that swings in the vertical direction.

The detection light emitted from the light emitting unit 20 passes through the half mirror 36 and scans across a predetermined scanning range in the horizontal direction in units of the unit scan angle, that is, across the rotational angle, via the scanning mechanism 35. The reflected light, which is the detection light reflected by an object, passes through the same optical path as the detection light, is reflected by the half mirror 36, and enters the light receiving unit 30 per unit scan angle. The unit scan angle at which the distance measuring process is executed, that is, the scan column is sequentially incremented for example from N to N+1. As a result, combining the light reception results of all the scan columns enables the distance measuring process over a desired scanning range, that is, the scanning for detecting an object. Note that, in the present embodiment, the reflected light enters the corresponding one of the light-receiving regions Ra1 to Ra4 corresponding to the detection light exclusively emitted from each of the light-emitting elements LD1 to LD4. Thus, the light-receiving regions Ra1 to Ra4 are classified into the light-receiving subject region corresponding to the emission of the exclusive detection light and the light-receiving non-subject region that does not correspond to the emission of the exclusive detection light. Note that, the light-receiving subject region may be referred to as the light-receiving region in which the reflected light of the detection light should enter, and the light-receiving non-subject region may be referred to as the light-receiving region in which the reflected light of the detection light should not enter. The light emitting unit 20 and the light receiving unit 30 may be rotated by the electric motor 42 together with the scanning mechanism 35. Alternatively, the light emitting unit 20 and the light receiving unit 30 may be separate from the scanning mechanism 35 and do not necessarily have to be rotated by the electric motor 42. Furthermore, the scanning mechanism 35 may be omitted. In this case, the multiple light-emitting elements 22 arranged in an array and the light-receiving element array 32 may be provided to directly emit a laser beam to the outside and directly receive the reflected light.

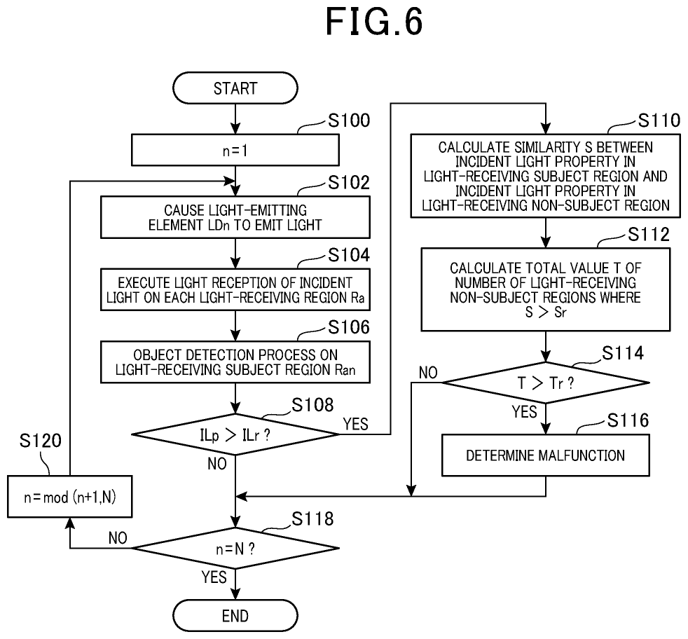

A process for determining a malfunction executed by the distance measuring device 100, or more specifically, the control unit 10 will be described with reference to FIG. 6. The process flow shown in FIG. 6 is repeatedly executed at, for example, predetermined intervals such as of several milliseconds after the distance measuring device 100 is started. When the distance measuring device 100 is mounted on a vehicle, the process flow may be repeatedly executed at predetermined intervals such as of several milliseconds during the time period after the system of the vehicle is started until the system is terminated or during the time period in which the operation switch of the distance measuring device 100 is switched on. Alternatively, the process flow may be executed at a predetermined number of times at an arbitrary timing such as when the system of the vehicle is started or terminated.

The CPU 11 initializes the counter n, that is, sets n to 1 (step S100). The CPU 11 outputs the light emission control signal to the light emitting unit 20 to cause the light-emitting element LDn to emit light (step S102). The CPU 11 outputs a light reception control signal to the light receiving unit 30 to cause the light receiving unit 30 to simultaneously execute the light-receiving process of the incident light on each of the light-receiving regions Ra1 to Ra4 (step S104). The CPU 11 generates a histogram indicating the property of the incident light intensity for each of the light-receiving regions Ra1 to Ra4 as shown in FIG. 3 using the detection signal, that is, the incident light intensity signal, input from the light receiving unit 30 and stores the histograms in the region-specific histogram storage region 12a of the memory 12. The generated histograms have the incident light intensity on the vertical axis and the time t [μs] taken from when the detection light is emitted to when the incident light enters on the horizontal axis, and indicate the incident light intensity relative to the time of incidence for unit scan angle. Thus, the peak value of the waveform W of the incident light intensity indicates the possibility of the existence of an object, and the distance [m] between the distance measuring device 100 and the object can be calculated using the time t. FIG. 3 shows exemplary histograms for each of the light-receiving regions Ra1 to Ra4 in the column N when n=1. Each of the histograms show the corresponding one of the signal waveforms Wa1 to Wa4 of the incident light intensity for each of the light-receiving regions Ra1 to Ra4. When n=1, the light-emitting element LD1 emits light, the light-receiving region Ra1 corresponds to the light-receiving subject region, and the light-receiving regions Ra2 to Ra4 correspond to the light-receiving non-subject regions. In the present embodiment, since the light-receiving element array 32 includes multiple light-receiving regions Ra1 to Ra4, the light-receiving processes can be simultaneously executed at the light-receiving subject region and the light-receiving non-subject regions. Note that, as shown in FIG. 3, the histograms are generated in the same manner for the scan column N−1 and the scan column N+1.

The CPU 11 executes the object detection process for the light-receiving subject region Ran (step S106). Specifically, the CPU 11 executes the distance measuring process of acquiring a peak value ILp of the incident light intensity in the light-receiving subject region Ran using the generated histogram and calculating the distance to an object using the time t at which the peak value ILp occurs. The CPU 11 determines whether the peak value ILp of the incident light intensity in the light-receiving subject region Ran is greater than an object determination value ILr that is previously set to determine the presence/absence of an object, that is, whether ILp>ILr (step S108). The incident light that enters the light-receiving element array 32 includes disturbance light caused by ambient light such as sunlight and street light in addition to the reflected light which is the detection light reflected from an object. Given the circumstances, the object determination value ILr is used to determine whether the incident light results from the disturbance light or the reflected light. The accuracy in determining a malfunction is improved by judging the correlation between the light-receiving subject region including the object and the light-receiving non-subject regions. Furthermore, when there is a large amount of disturbance light, the peak value ILp of the incident light intensity is also decreased, which also decreases the reliability of the light reception result. Thus, the process for determining a malfunction is not performed. In the example of FIG. 3, the peak value ILp of the signal waveform Wa1 of the incident light intensity in the light-receiving subject region Ra1 is greater than the object determination value ILr. Thus, it is determined that the light-receiving subject region Ra1 includes an object.

Upon determining that ILp>ILr (step S108: Yes), the CPU 11 executes the process for determining a malfunction regarding at least one of the light receiving unit and the light emitting unit in accordance with the difference between the property of the incident light intensity in the light-receiving subject region and the property of the incident light intensity in the light-receiving non-subject regions, using each of the light-receiving regions Ra1 to Ra4 stored in the region-specific histogram storage region 12a of the memory 12. The CPU 11 determines whether there is a correlation between the property of the incident light intensity in the light-receiving subject region and the property of the incident light intensity in the light-receiving non-subject regions. The correlation refers to the similarity between the waveforms of the incident light intensity with respect to time or the approximation degree of the peak occurrence time in the waveforms of the incident light intensity with respect to time. In the present process flow, the CPU 11 calculates the similarity S as the index representing the correlation (step S110). The similarity S takes a value of 0 to 1, and the greater the value, the higher the correlation between the property of the incident light intensity in the light-receiving subject region and the property of the incident light intensity in the light-receiving non-subject regions. When n=1, the light-receiving subject region corresponds to the light-receiving region Ra1, and the light-receiving non-subject regions correspond to the light-receiving regions Ra2 to Ra4. The property of the incident light intensity includes, for example, the peak value, the histogram, the mean of the histogram which is the luminance value in this case. When the histogram is used, discrete values of the incident light intensity at multiple time sampling points of the waveform W, or the peak occurrence time is used. The property of the incident light intensity may also be a statistical value such as the median, mean, and variance of the luminance value. The similarity is obtained by methods such as the known cosine similarity and cluster analysis when, for example, the discrete values of the incident light intensity at multiple time sampling points of the waveform W are used. Instead of the similarity S, the peak occurrence time, that is, the approximation degree of the time t may be used, and whether the approximation degree is greater than a predetermined determination approximation degree only needs to be determined like in the case of the similarity S. When the latter statistical value is used, for example, the waveforms are determined to be similar when the difference between the values is included in a predetermined range, and the waveforms are determined to be dissimilar when the difference between the values exceeds the predetermined range.

The CPU 11 obtains a total value T by counting the light-receiving non-subject regions where the calculated similarity S is greater than a determination similarity Sr, that is, the light-receiving non-subject regions where S>Sr (step S112). The determination similarity Sr is a determination value for distinguishing the light-receiving non-subject regions that should not be similar to the histogram of the light-receiving subject region if there is no malfunction in the light-receiving system and is, for example, 0.5 to 1. In the example of FIG. 3, for example, the light-receiving Ra2 is counted as the light-receiving non-subject region where S>Sr, and the light-receiving regions Ra3 and Ra4 are not counted as the light-receiving non-subject region where S>Sr. Note that, the CPU 11 may store, in the memory 12, the maximum number nmax and the minimum number nmin of the light-receiving non-subject regions where S>Sr. The CPU 11 determines whether the total value T is greater than a malfunction determination value Tr, that is, whether T>Tr (step S114). Taking into consideration the decrease in the accuracy or the reliability of the calculated similarity S due to the influence of the disturbance light, the present embodiment improves the accuracy in determining a malfunction using the total value of the light-receiving non-subject regions where the similarity S is higher than the determination similarity Sr. Since the reflected light from the object does not enter the light-receiving non-subject region when there is no malfunction in at least of the light receiving unit and the light emitting unit of the distance measuring device 100, in the present embodiment, the malfunction determination value Tr may be 1, or may be 2 or 3 taking the disturbance light element into consideration.

Upon determining that T>Tr (step S114: Yes), the CPU 11 determines that there is a malfunction in at least one of the light receiving unit and the light emitting unit of the distance measuring device 100 such as in the light-emitting element 22, the light-receiving element array 32, the cover glass 37, and the scanning mechanism 35 (step S116) and proceeds to step S118. Upon determining that the total value T is not greater than the malfunction determination value Tr (step S114: No), the CPU 11 proceeds to step S118 without determining that there is a malfunction in at least one of the light receiving unit and the light emitting unit of the distance measuring device 100. Note that, the CPU 11 may notify a driver of the malfunction in the distance measuring device when the occurrence of a malfunction is determined. Additionally, the CPU 11 may log the occurrence of a malfunction in the memory 12. For example, the CPU 11 may record the total value T as an index representing the level of the malfunction. Furthermore, the CPU 11 may record the light-receiving non-subject region furthest from the light-receiving subject region among the light-receiving non-subject regions where S>Sr as an index representing the level of the malfunction using the maximum number nmax and the minimum number nmin of the light-receiving non-subject regions relative to the light-receiving subject region stored in the memory 12. In this case, the greater the total value T and the further the light-receiving non-subject region, the greater the level of the malfunction.

At step S108, upon determining that ILp is not greater than ILr, that is, ILp<ILr (step S108: No), the CPU 11 proceeds to step S118. That is, when an object does not exist in the light-receiving subject region Ran, it is unnecessary to execute the process for determining a malfunction regarding at least one of the light receiving unit and the light emitting unit involved in the object detection. Thus, the CPU 11 proceeds to step S118 without executing the similarity determination.

At step S118, the CPU 11 determines whether all the processes that set each of the light-receiving regions Ra1 to Ra4 as the light-receiving subject region are finished, that is, whether n=N. In this description, N is the number of the light-receiving regions included in the light-receiving element array 32, and N=4 in the present embodiment. Upon determining that n=N (step S118: Yes), the CPU 11 determines that all the processes that set each of the light-receiving regions Ra1 to Ra4 as the light-receiving subject region are finished and terminates the present routine. Upon determining that n is not equal to N (step S118: No), the CPU 11 increments n to change the subject light-receiving region (step S120) and proceeds to step S102.

When n is incremented to 2, 3, or 4, in the same manner as the case when n=1, the light-emitting element LD2, LD3, or LD4 and the light-receiving region Ra2, Ra3, or Ra4 are set as the subject, and steps S102 to S108 are executed. Upon determining that n=N (step S118: Yes), the CPU 11 determines that all the processes that set each of the light-receiving regions Ra1 to Ra4 as the light-receiving subject region are finished and terminates the present routine.

With the distance measuring device 100 according to the first embodiment described above, a malfunction in at least one of the light receiving unit and the light emitting unit of the distance measuring device 100 is determined in accordance with the difference between the property of the incident light intensity in the light-receiving subject region and the property of the incident light intensity in the light-receiving non-subject region. Thus, the distance measuring device 100 can determine a malfunction by itself regarding at least one of the light receiving unit and the light emitting unit, and the accuracy in determining a malfunction in at least one of the light receiving unit and the light emitting unit of the distance measuring device 100 is also improved. More specifically, with the distance measuring device 100 according to the first embodiment, a malfunction such as contamination of the cover glass 37 or displacement of at least one of the light receiving unit and the light emitting unit in the distance measuring device 100 can be determined in accordance with the similarity between the histogram of the light-receiving subject region and the histograms of the light-receiving non-subject regions among the light-receiving regions Ra1 to Ra4 of the light-receiving element array 32. Additionally, with the distance measuring device 100 according to the first embodiment, a malfunction in at least one of the light receiving unit and the light emitting unit can be determined using the light-receiving element array 32 of the distance measuring device 100.

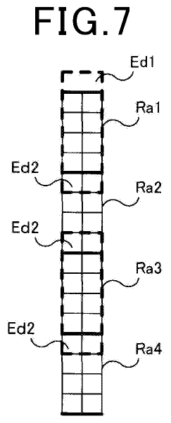

In the first embodiment, the light-receiving non-subject region that correlates with the light-receiving subject region was counted without taking into consideration whether the light-receiving subject region is either of the light-receiving regions Ra1 and Ra4 that are on the edges of the light-receiving element array 32 or either of the light-receiving regions Ra2 and Ra3 that are not on the edges of the light-receiving element array 32. As shown in FIG. 7, a malfunction of the light-receiving region Ra3 that is not on the edge of the light-receiving element array 32, such as the displacement in the light-receiving position, is detected as Ed2 on each of the light-receiving regions Ra2 and Ra4. In contrast, a malfunction of the light-receiving region Ra1 that is on the edge of the light-receiving element array 32 is not detected as a malfunction Ed1 while being detected as Ed2 on the light-receiving region Ra2. That is, the light-receiving region that correlates with the light-receiving region Ra1 on the edge is sometimes not counted correctly. Given the circumstances, for the light-receiving regions Ra1 and Ra4 that are on the edges, the number of the light-receiving non-subject region that correlates with the light-receiving subject region may be doubled or counted by adding 1. This further improves the accuracy in determining a malfunction in the light-receiving system.

In the first embodiment, the light emitting unit 20 including the four light-emitting elements LD1 to LD4 and the light-receiving element array 32 including the four light-receiving regions Ra1 to Ra4 are described as an example. However, the number of the light-emitting elements LD or light-emitting regions does not necessarily have to match the number of the light-receiving regions and may be less than four or five or more. Additionally, the number of the light-receiving regions may be less than or equal to the number of the light-receiving pixels, and the number of the irradiated regions or the light-emitting regions may be less than or equal to the number of light-emitting elements.

### Second Embodiment

In the process for determining a malfunction according to the first embodiment, a malfunction regarding at least one of the light receiving unit and the light emitting unit of the distance measuring device 100 is determined. In contrast, a process for determining a malfunction according to a second embodiment determines in which one of the light receiving unit and the light emitting unit a malfunction exists. Note that, the components of the distance measuring device according to the second embodiment that are the same as the components of the distance measuring device 100 according to the first embodiment are given the same reference numerals, and explanations are omitted.

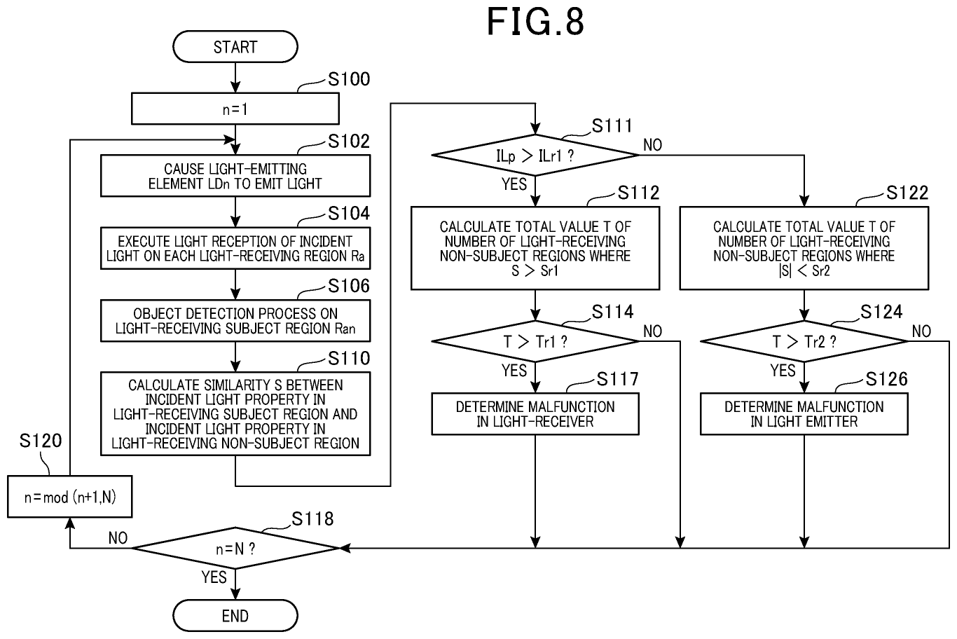

Referring to FIG. 8, the process for determining a malfunction according to the second embodiment executed by the distance measuring device 100, or more specifically, by the control unit 10 will be described. The process flow shown in FIG. 8 is executed in the same manner as the process flow shown in FIG. 6. Note that, the same reference numerals are given to those steps that are the same as the corresponding steps in the process flow shown in FIG. 6, and explanation is omitted.

The CPU 11 initializes the counter n, that is, sets n to 1 (step S100). The CPU 11 outputs the light emission control signal to the light emitting unit 20 to cause the light-emitting element LDn to emit light (S102). The CPU 11 executes the light-receiving process of the incident light on the light-receiving regions Ra1 to Ra4 of the light receiving unit 30, generates a histogram of each of the light-receiving regions Ra1 to Ra4 using the incident light intensity signals, and stores the generated histograms in the region-specific histogram storage region 12a of the memory 12 (step S104).

The CPU 11 executes the object detection process for the light-receiving subject region Ran (step S106). More specifically, the CPU 11 acquires the peak value ILp of the incident light intensity in the light-receiving subject region Ran using the generated histogram. The CPU 11 calculates the similarity S between the property of the incident light intensity in the light-receiving subject region and the property of the incident light intensity in the light-receiving non-subject regions using the light-receiving regions Ra1 to Ra4 stored in the region-specific histogram storage region 12a of the memory 12 (step S110).

The CPU 11 determines whether the peak value ILp of the incident light intensity in the light-receiving subject region Ran is greater than the object determination value ILr previously set to determine the presence/absence of an object, that is, whether ILp>ILr (step S111).

Upon determining that ILp>ILr (step S111: Yes), the CPU 11 obtains the total value T by counting the light-receiving non-subject region where the calculated similarity S is greater than a first determination similarity Sr1, that is, the light-receiving non-subject region where S>Sr1 (step S112). The CPU 11 determines whether the total value T is greater than a first malfunction determination value Tr1, that is, whether T>Tr1 (step S114). Upon determining that T>Tr1 (step S114: Yes), the CPU 11 determines that a malfunction has occurred in the light receiving unit of the distance measuring device 100, more specifically, in the light-receiving system, such as the light-receiving element array 32, the scanning mechanism 35, the half mirror 36, and the cover glass 37 (step S117) and proceeds to step S118. Upon determining that T is not greater than Tr1 (step S114: No), the CPU 11 proceeds to step S118 without determining a malfunction in the distance measuring device 100.

At step S111, when ILp is not greater than ILr (step S111: No), the CPU 11 determines that there is no object in the light-receiving subject region Ran and obtains the total value T by counting the light-receiving non-subject region where the absolute value of the calculated similarity S is smaller than a second determination similarity Sr2, that is, the light-receiving non-subject region where |S|<Sr2 (step S122). When an object does not exist in the light-receiving subject region Ran, no object is supposed to be detected in the light-receiving non-subject region either, and the similarity S between the property of the incident light intensity in the light-receiving subject region and the property of the incident light intensity in the light-receiving non-subject region should be approximate. Thus, the second determination similarity Sr2 is used to determine the light-receiving non-subject region where the similarity between the light-receiving non-subject region and the light-receiving subject region is not approximate, that is, the light-receiving non-subject region that has the peak value of the incident light intensity corresponding to an object. The second determination similarity Sr2 takes a value of, for example, 0 to 0.4. The CPU 11 determines whether the total value T is greater than the second malfunction determination value Tr2, that is, whether T>Tr2 (step S124). When an object does not exist or is not detected in the light-receiving subject region, no object should be detected either in the light-receiving non-subject region that is not associated with the detection light. Thus, the second malfunction determination value Tr2 is, for example, 0. Upon determining that T>Tr2 (step S124: Yes), the CPU 11 determines that a malfunction has occurred in the light emitting unit of the distance measuring device 100, or more specifically, in the light-emitting system such as the light-emitting element 22, the scanning mechanism 35, the half mirror 36, and the cover glass 37 (step S126) and proceeds to step S118. Upon determining that T is not greater than Tr2 (step S124: No), the CPU 11 proceeds to step S118 without determining a malfunction in the distance measuring device 100.

At step S118, the CPU 11 determines whether all the processes that set each of the light-receiving regions Ra1 to Ra4 as the light-receiving subject region are finished, that is, whether n=N. In this description, N is the number of the light-receiving regions of the light-receiving element array 32, and N is 4 in the present embodiment. Upon determining that n=N (step S118: Yes), the CPU 11 determines that all the processes that set each of the light-receiving regions Ra1 to Ra4 as the light-receiving subject region are finished and terminates the present routine. Upon determining that n is not equal to N (step S118: No), the CPU 11 increments n to change the subject light-receiving region (step S120) and proceeds to step S102.

When n is incremented to 2, 3, or 4, in the same manner as the case when n=1, the light-emitting element LD2, LD3, or LD4 and the light-receiving subject region Ra2, Ra3, or Ra4 are set as the subject, and step S102 and the following steps are executed. Upon determining that n=N (step S118: Yes), the CPU 11 determines that all the processes that set each of the light-receiving regions Ra1 to Ra4 as the light-receiving subject region are finished and terminates the present routine.

In addition to the advantages achieved by the distance measuring device 100 according to the first embodiment, the distance measuring device 100 according to the second embodiment determines whether a malfunction in the distance measuring device 100 is a malfunction in the light receiving unit or a malfunction in the light emitting unit. This further improves the accuracy in determining a malfunction regarding at least one of the light receiving unit and the light emitting unit of the distance measuring device 100.

### Third Embodiment

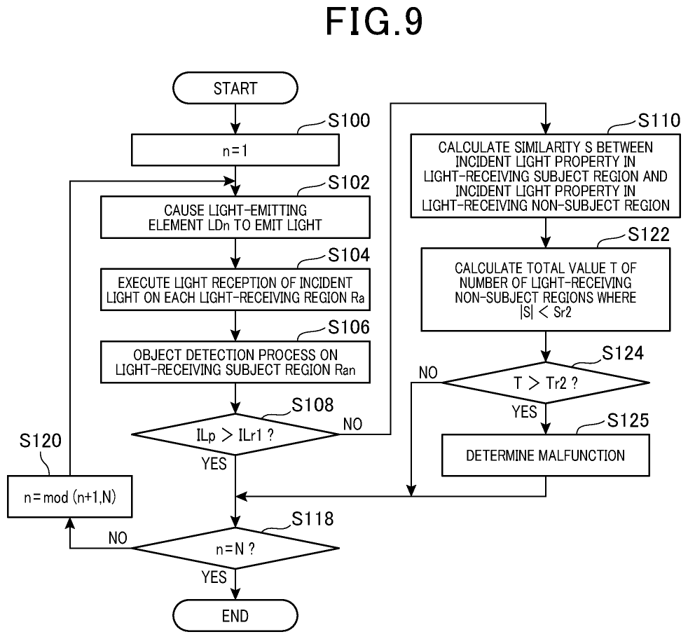

Referring to FIG. 9, a process for determining a malfunction according to a third embodiment executed by the distance measuring device 100, or more specifically, the control unit 10 will be described. The process flow shown in FIG. 9 is executed in the same manner as the process flow shown in FIG. 6. Note that, the same reference numerals are given to those steps that are the same as the corresponding steps in the process flow shown in FIG. 6 or FIG. 8, and explanation is omitted.

The CPU 11 initializes the counter n, that is, sets n to 1 (step S100). The CPU 11 outputs the light emission control signal to the light emitting unit 20 to cause the light-emitting element LDn to emit light (S102). The CPU 11 executes the light-receiving process of the incident light on the light-receiving regions Ra1 to Ra4 of the light receiving unit 30, generates a histogram of each of the light-receiving regions Ra1 to Ra4 using the incident light intensity signals, and stores the generated histograms in the region-specific histogram storage region 12a of the memory 12 (step S104).

The CPU 11 executes the object detection process for the light-receiving subject region Ran (step S106). More specifically, the CPU 11 acquires the peak value ILp of the incident light intensity in the light-receiving subject region Ran using the generated histogram.

The CPU 11 determines whether the peak value ILp of the incident light intensity in the light-receiving subject region Ran is greater than the object determination value ILr previously set to determine the presence/absence of an object, that is, whether ILp>ILr (step S108). Upon determining that ILp>ILr (step S108: Yes), the CPU 11 proceeds to step S118.

When ILp is not greater than ILr (step S108: No), the CPU 11 determines that an object does not exist in the light-receiving subject region Ran and calculates the similarity S between the property of the incident light intensity in the light-receiving subject region and the property of the incident light intensity in the light-receiving non-subject region using each of the light-receiving regions Ra1 to Ra4 stored in the region-specific histogram storage region 12a of the memory 12 (step S110). The CPU 101 obtains the total value T by counting the light-receiving non-subject region where the absolute value of the calculated similarity S is smaller than the second determination similarity Sr2, that is, the light-receiving non-subject region where |S|<Sr2 (step S122). When an object does not exist in the light-receiving subject region Ran, no object is supposed to be detected in the light-receiving non-subject region either, and the similarity S between the property of the incident light intensity in the light-receiving subject region and the property of the incident light intensity in the light-receiving non-subject region should be approximate. The CPU 11 determines whether the total value T is greater than the second malfunction determination value Tr2, that is, whether T>Tr2 (step S124). When an object does not exist or is not detected in the light-receiving subject region, no object should be detected either in the light-receiving non-subject region that is not associated with the detection light. Thus, the second malfunction determination value Tr2 is, for example, 0. Upon determining that T>Tr2 (step S124: Yes), the CPU 11 determines that a malfunction has occurred in at least one of the light receiving unit and the light emitting unit of the distance measuring device 100 (step S125) and proceeds to step S118. Upon determining that T is not greater than Tr2 (step S124: No), the CPU 11 proceeds to step S118 without determining the occurrence of a malfunction in the distance measuring device 100.

At step S118, the CPU 11 determines whether all the processes that set each of the light-receiving regions Ra1 to Ra4 as the light-receiving subject region are finished, that is, whether n=N. In this description, N is the number of the light-receiving regions included in the light-receiving element array 32, and N=4 in the present embodiment. Upon determining that n=N (step S118: Yes), the CPU 11 determines that all the processes that set each of the light-receiving regions Ra1 to Ra4 as the light-receiving subject region are finished and terminates the present routine. Upon determining that n is not equal to N (step S118: No), the CPU 11 increments n to change the subject light-receiving region (step S120) and proceeds to step S102.

When n is incremented to 2, 3, or 4, like the case in which n is equal to 1, the light-emitting element LD2, LD3, or LD4 and the light-receiving region Ra2, Ra3, or Ra4 are set as the subject, and step S102 and the following steps are executed. Upon determining that n=N (step S118: Yes), the CPU 11 determines that all the processes that set each of the light-receiving regions Ra1 to Ra4 as the light-receiving subject region are finished and terminates the present routine.

Like the distance measuring device 100 according to the first embodiment, the distance measuring device 100 according to the third embodiment described above determines a malfunction regarding at least one of the light receiving unit and the light emitting unit of the distance measuring device 100 by itself, and the accuracy in determining a malfunction in at least one of the light receiving unit and the light emitting unit of the distance measuring device 100 is improved.

### OTHER EMBODIMENTS

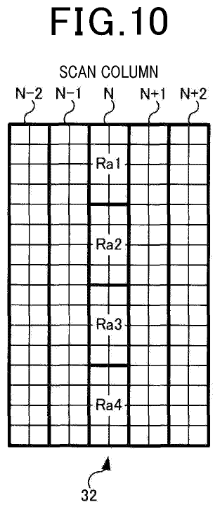

(1) In each of the above embodiments, the light receiving unit 30 including the light-receiving element array 32 that corresponds to the scan column is used as shown in FIG. 3. In contrast, for example, the light receiving unit 30 that includes the light-receiving element array 32 corresponding to the scan columns N−2 to N+2 as shown in FIG. 10 may be used. In this case, plenty of time is allowed for the light-receiving process. Additionally, in each of the above embodiments, the scanning mechanism 35 that scans in the horizontal direction is described as an example, and the light-receiving element array 32 includes multiple light-receiving regions arranged in the vertical direction. In contrast, when the scanning mechanism 35 scans in the vertical direction, the light-receiving element array 32 may include multiple light-receiving regions arranged in the horizontal direction.

(2) In each of the above embodiments, when the similarity S between the light-receiving subject region and all the light-receiving non-subject regions is higher than the determination similarities Sr or Sr1, that is, when there is a correlation between all the light-receiving regions, the light emission intensity of the detection light emitted by the light emitting unit 20 may be decreased, and the process for determining a malfunction may be executed again. When there is a correlation between the properties of the incident light intensity in all the light-receiving regions, reflected light from a highly reflective object, such as a reflector, may possibly be incident on the light receiving unit 30 as disturbance light. Given the circumstances, the light emission intensity of the detection light may be decreased to decrease the intensity of the reflected light from the reflector, so that the signal-noise (S/N) ratio of the reflected light from the object is improved against the reflected light from the reflector.

(3) In each of the above embodiments, in determining the similarity S between the light-receiving subject region and all the light-receiving non-subject regions, the similarity S may be determined using the histograms excluding the clutter. Clutter refers to the phenomenon in which the peak occurs at the beginning or the head of the histogram including the time t=0, or the measured distance of 0 m, when the detection light is reflected by the cover glass 37. In this case, the accuracy in determining the similarity S is improved by eliminating or reducing the influence of the peak, which is noise.

(4) In each of the above embodiments, in the process for determining a malfunction, the process for detecting an object in the light-receiving subject region, that is, the distance measuring process is executed. However, the process for detecting an object does not necessarily have to be executed in the process for determining a malfunction. That is, the process for detecting an object and the process for determining a malfunction may be separately executed. In this case, the execution frequency of the process for determining a malfunction may be lower than that of the process for detecting an object. Additionally, the light-receiving process of the incident light on each of the light-receiving regions Ra1 to Ra4 of the light receiving unit 30 does not necessarily have to be performed simultaneously unless the process overlaps the timing at which light is emitted from the light emitting unit 20. Furthermore, the process for determining a malfunction only requires acquiring or generating the property of the incident light intensity regarding each light-receiving region Ra and determining a malfunction in accordance with the difference between the property of the incident light intensity regarding the light-receiving subject region and the property of the incident light intensity regarding the light-receiving non-subject regions. The determination of whether the peak value ILp of the incident light intensity in the light-receiving subject region is greater than the object determination value ILr and the determination of whether the total value of the number of a light-receiving non-subject region having a correlation with the light-receiving subject region is greater than the malfunction determination value Tr only need to be executed to improve the accuracy in determining a malfunction.

(5) In each of the above embodiments, the control unit 10 that executes a variety of processes including the process for determining a malfunction is achieved by means of software with the control unit 10 that executes programs, but may be achieved by means of hardware using a pre-programmed integrated circuit or a discrete circuit. That is, the control unit and the method of each of the above embodiments may be achieved by a dedicated computer that includes a processor and a memory programmed to execute one or more functions implemented as computer programs. Alternatively, the control unit and the method disclosed in the present disclosure may be achieved by a dedicated computer provided by configuring a processor with one or more dedicated hardware logic circuits. Alternatively, the control unit and the method disclosed in the present disclosure may be achieved by one or more dedicated computers configured by combining a processor and a memory programmed to execute one or more functions and a processor configured by one or more hardware logic circuits. Additionally, the computer program may be stored in a non-transitory, tangible computer-readable storage medium as an instruction executed by a computer.

Although the present disclosure has been described on the basis of the embodiments and modifications, it should be understood that the embodiments of the invention described above are given to facilitate understanding of the present disclosure and do not limit the present disclosure. The present disclosure may be changed or improved without departing from the spirit and scope of the present disclosure, and their equivalents are included in the present disclosure. For example, embodiments corresponding to the technical characteristics of each embodiment disclosed in Summary of the Invention and the technical characteristics of the modifications may be replaced or combined as required to solve part or all of the above-described problem or achieve part or all of the above-described advantages. Unless otherwise the technical characteristics are described as essential in the present description, the technical characteristics may be omitted as required.

What is claimed is:

1. A distance measuring device comprising:
a light receiving unit configured to include a plurality of light-receiving regions for receiving incident light and receive the incident light in units of each light-receiving region;
a light emitting unit configured to exclusively emit detection light to the outside corresponding to each light-receiving region; and
a malfunction determining unit configured to perform, in response to the light receiving unit receiving the incident light according to the emission of the detection light, malfunction determination regarding at least one of the light receiving unit and the light emitting unit, in accordance with a difference between a property of incident light intensity in a light-receiving subject region and a property of incident light intensity in a light-receiving non-subject region, a region corresponding to exclusive emission of the detection light among the plurality of light-receiving regions serving as the light-receiving subject region, and a region failing to correspond to exclusive emission of the detection light among the plurality of light-receiving regions serving as the light-receiving non-subject region.

2. The distance measuring device according to claim 1, wherein
the malfunction determining unit is configured to perform the malfunction determination in accordance with the difference between the property of the incident light intensity in the light-receiving subject region and the property of the incident light intensity in the light-receiving non-subject region, in response to the light-receiving regions simultaneously receiving the incident light.

3. The distance measuring device according to claim 1, wherein
the malfunction determining unit is configured to determine that a malfunction has occurred in the distance measuring device in response to the property of the incident light intensity in the light-receiving subject region has a correlation with the property of the incident light intensity in the light-receiving non-subject region.

4. The distance measuring device according to claim 3, wherein
the correlation is a similarity of a waveform of the incident light intensity with respect to time, and
the malfunction determining unit is configured to determine that a malfunction has occurred in the distance measuring device in response to the similarity being greater than a predetermined determination similarity.

5. The distance measuring device according to claim 3, wherein
the correlation is an approximation degree of a peak occurrence time in a waveform of the incident light intensity with respect to time, and
the malfunction determining unit is configured to determine that a malfunction has occurred in the distance measuring device in response to the approximation degree being greater than a predetermined determination approximation degree.

6. The distance measuring device according to claim 1, wherein
the malfunction determining unit is configured to perform the malfunction determination in response to a reflected light resulting from the detection light entering the light-receiving subject region.

7. The distance measuring device according to claim 3, wherein
the malfunction determining unit is configured to determine that a malfunction has occurred in the distance measuring device in response to a reflected light resulting from the detection light failing to enter the light-receiving subject region, and a number of a light-receiving non-subject region failing to have the correlation being greater than a predetermined second malfunction determination value.

8. The distance measuring device according to claim 3, wherein the malfunction determining unit is configured to:
determine that a malfunction has occurred in the light receiving unit in response to a reflected light resulting from the detection light entering the light-receiving subject region, and a number of a light-receiving non-subject region having the correlation being greater than a predetermined malfunction determination value, and
determine that a malfunction has occurred in the light emitting unit in response to a reflected light resulting from the detection light failing to enter the light-receiving subject region, and a number of a light-receiving non-subject region failing to have the correlation being greater than a predetermined second malfunction determination value.

9. A malfunction determination method for a distance measuring device, the distance measuring device including a light receiving unit and a light emitting unit, the malfunction determination method comprising:
exclusively emitting detection light to the outside, in units of each of a plurality of light-receiving regions included in the light receiving unit; and
executing, in response to the light receiving unit receiving incident light according to the emission of the detection light, malfunction determination regarding at least one of the light receiving unit and the light emitting unit, in accordance with a difference between a property of incident light intensity in a light-receiving subject region and a property of incident light intensity in a light-receiving non-subject region, a region corresponding to exclusive emission of the detection light among the plurality of light-receiving regions serving as the light-receiving subject region, and a region failing to correspond to exclusive emission of the detection light among the plurality of light-receiving regions serving as the light-receiving non-subject region.
